(19) United States
(12) Patent Application Publication
(10) Pub. No.: US 2024/0262316 A1
(43) Pub. Date: Aug. 8, 2024

(54) CLEANING LIQUID RESERVOIR SYSTEM, SENSOR CLEANING SYSTEM, VEHICLE

(71) Applicant: ZF CV Systems Global GmbH, Bern (CH)

(72) Inventors: Guillermo Bertolina, Brussels (BE); Rodrigo Magalhaes Pereira, Augsburg (DE); Archishmaan Vishwanathan, Chennai (IN)

(21) Appl. No.: 18/634,543

(22) Filed: Apr. 12, 2024

Related U.S. Application Data
(63) Continuation of application No. PCT/EP2022/076663, filed on Sep. 26, 2022.

(30) Foreign Application Priority Data
Oct. 18, 2021 (IN) 202111047209

(51) Int. Cl. B60S 1/50; B60S 1/48; B60S 1/52; B60S 1/56

(52) U.S. Cl. CPC B60S 1/50; B60S 1/481; B60S 1/487; B60S 1/52; B60S 1/56

(57) ABSTRACT

A cleaning liquid reservoir system for a vehicle is configured to store a cleaning liquid for cleaning at least one surface of the vehicle. The system includes a main reservoir, configured to store a main amount of the cleaning liquid, and a pump for the cleaning liquid. At least one satellite reservoir is provided, configured to store a further amount of the cleaning liquid. The cleaning liquid reservoir system includes a liquid sensing device, configured to detect a presence of the cleaning liquid outside of the main reservoir and in such case provide a liquid presence signal. The main reservoir is connected to the at least one satellite reservoir via a fluid line. The pump is configured to pump the cleaning liquid from the main reservoir to the at least one satellite reservoir. The pump is configured to be deactivated upon receiving the liquid presence signal.

### CROSS-REFERENCE TO RELATED APPLICATIONS

This application is a continuation application of international patent application PCT/EP2022/076663, filed Sep. 26, 2022, designating the United States and claiming priority from Indian application Ser. No. 20/211,1047209, filed Oct. 18, 2021, and the entire content of both applications is incorporated herein by reference.

### TECHNICAL FIELD

The disclosure relates in a first aspect to a cleaning liquid reservoir system. The disclosure further relates in a second aspect to a sensor cleaning system and in a third aspect to a vehicle.

### BACKGROUND

Reservoirs for storing cleaning liquid in vehicles are generally known. Cleaning liquids are used for cleaning surfaces that are exposed to the environment and accumulate debris, dirt or the like during the operation of the vehicle. For this purpose, the reservoir in a vehicle is configured to provide cleaning liquid to one or more cleaning modules that are adapted to apply the cleaning liquid to the surface to be cleaned.

In cleaning systems for vehicles, it is generally a challenge to provide a sufficient amount of cleaning liquid for cleaning modules in different areas of the vehicle, in particular in light of the motivation of reduced lengths of fluid line and produced pressure loss.

DE 10 2017 201 756 B4 discloses a cleaning system for a motor vehicle, with at least one container for storing cleaning liquid, which can be conveyed to a respective cleaning nozzle via a line system via at least one pump, wherein the at least one pump is arranged outside the container within the line system. The approach disclosed in DE 10 2017 201 756 B4 is based on a liquid connection with a ring topology.

Despite such generally favorable approach, cleaning systems, and in particular cleaning liquid reservoir systems, can still be improved, in particular with respect to a uniform and efficient distribution of cleaning liquids to different regions of the vehicle.

### SUMMARY

It is an object of the disclosure to provide a cleaning liquid reservoir system that is improved, in particular with respect to a uniform and efficient distribution of a cleaning liquids.

In accordance with the disclosure, a cleaning liquid reservoir system for a vehicle is configured to store a cleaning liquid for cleaning at least one surface of the vehicle. The cleaning liquid reservoir system includes: a main reservoir configured to store a main amount of the cleaning liquid; a pump for pumping the cleaning liquid; at least one satellite reservoir configured to store a further amount of the cleaning liquid; a liquid sensing device configured to detect a presence of the cleaning liquid outside of the main reservoir and to provide a liquid presence signal when the presence of the cleaning liquid outside the main reservoir is detected; the main reservoir being connected to the at least one satellite reservoir via a fluid line; the pump being configured to pump the cleaning liquid from the main reservoir to the at least one satellite reservoir; and, the pump being further configured to be deactivated upon receiving the liquid presence signal.

According to the disclosure, at least one satellite reservoir is proposed, adapted to store a further amount of the cleaning liquid, wherein the cleaning liquid reservoir system includes a liquid sensing device, adapted to detect a presence of the cleaning liquid outside of the main reservoir and in such case provide a liquid presence signal. The main reservoir is connected to the at least one satellite reservoir via a fluid line, and the pump is adapted to pump the cleaning liquid from the main reservoir to the at least one satellite reservoir, wherein the pump is adapted to be deactivated upon receiving the liquid presence signal.

The disclosure includes the finding that a structure with the main reservoir and at least one satellite reservoir is advantageous to provide cleaning liquid to different regions of the vehicle. Providing a further amount of the cleaning liquid in a satellite reservoir in such region enables a reliable supply of cleaning liquid to sensor cleaning modules in that region. Further, such structure results in relatively short liquid connections, that is, fluid lines, between the satellite reservoir and a sensor cleaning module, resulting in reduced pressure losses, in particular compared to a conventional, centralized structure with only one main reservoir. Through a liquid sensing device, that is adapted to detect a presence of the cleaning liquid outside of the main reservoir, a presence of the cleaning liquid in a location of the cleaning liquid reservoir system can be detected and this information can be used for controlling the pump. The term “outside of the main reservoir” refers to a cleaning liquid containing part of the cleaning liquid reservoir system other than the main reservoir.

Further embodiments of the disclosure can be found in the dependent claims and show particularly advantageous possibilities to realize above-described concept in light of the object of the disclosure and regarding further advantages.

Preferably, the pump is adapted to be activated by the electronic control unit by providing a liquid request signal. Preferably, the pump is adapted to be deactivated by the electronic control unit by interrupting, that is not providing, the liquid request signal. Preferably, the liquid request signal is an electric voltage.

It is preferably suggested that the main reservoir has a larger capacity than the satellite reservoir. In such an embodiment, the main reservoir can serve as a supply of cleaning liquid for at least one smaller-sized satellite reservoir, preferably for multiple satellite reservoirs. In such embodiments, the refilling of a cleaning liquid is facilitated, as only the main reservoir needs to be refilled, once the cleaning liquid is depleted. Preferably, the main reservoir has a capacity in the range of 2,0 Liters to 20 Liters. Preferably, the satellite reservoir has a capacity in the range of 0,25 Liter to 5 Liters. Preferably, the liquid sensing device is arranged in the satellite reservoir and/or in the fluid line.

In accordance with a further embodiment, a consumption estimation module is proposed, adapted to estimate a consumption estimation value of the cleaning liquid and to provide a liquid request signal when the consumption estimation value reaches a consumption estimation threshold, wherein the pump is adapted to be activated upon receiving the liquid request signal. Via a consumption estimation module, the consumption of cleaning liquid can be estimated. Preferably, the consumption estimation module is configured as a software module or the like module implementing an algorithm for estimating a consumption as described above. Preferably, the consumption estimation module is adapted to estimate the consumption of cleaning liquid by counting the number of performed cleaning cycles. Preferably, the consumption estimation module can include, or be connected to, at least one sensor cleaning module or a plurality of a sensor cleaning modules supplied by a satellite reservoir or a sensor cleaning control unit, such that the amount of performed cleaning cycles can be counted. In various embodiments, the consumption of cleaning liquid of one sensor cleaning module per cleaning cycle can be an amount in the range of 2 to 6 ml. Via such connection, the actual consumption of cleaning liquid can be estimated, in particular without any further sensors or the like equipment. With a consumption estimation module, it can be assured that the satellite reservoirs are sufficiently filled with cleaning fluid, ensuring the availability of cleaning fluid.

In accordance with a further embodiment, an electronic control unit is proposed, adapted to control the pump in dependence of the liquid presence signal and/or of the liquid request signal. Preferably, the electronic control unit is configured as a hardware module or as a software module. The electronic control unit can be part of a different control module of the vehicle, such as a vehicle control unit. In other embodiments, the electronic control unit can be a control unit assigned to the cleaning liquid reservoir system or to a sensor cleaning system or another control unit of the vehicle. Preferably, the electronic control unit includes the consumption estimation module.

In accordance with a further embodiment, it is proposed that the satellite reservoir has a liquid exit port, arranged in a top region of the satellite tank. “Top region” refers to a region of the reservoir in the upper 25%, preferably in the upper 10%, more preferably in the upper 5% of the reservoir, wherein “upper” refers to a vertical vehicle axis. A liquid exit port arranged in the top region is in particular advantageous for embodiments, where the at least one satellite reservoir is connected to the main reservoir in series. This is in particular because when refilling, the cleaning liquid will be passed to the subsequent satellite reservoir only when the liquid level has reached the top region of a certain satellite reservoir. Thus, each satellite reservoir will be filled subsequently.

It is accordingly advantageous that at least two, preferably each, of the at least one satellite reservoir are connected to the main reservoir in series via the fluid line. A serial topology of satellite reservoirs advantageously results in a reduced amount and/or reduced lengths of fluid lines.

An embodiment suggests that the liquid sensing device is a flow sensor and is preferably arranged in a liquid return line connecting the last satellite reservoir in series with the main reservoir. Embodiments with a flow sensor arranged in the liquid return line are particularly advantageous in combination with a serial topology of satellite reservoirs. This is in particular because when such flow sensor detects the presence of cleaning liquid, it can be safely concluded that all satellite reservoirs have been completely filled with the cleaning liquid, preferably each up to its liquid exit port. As a consequence, the liquid presence signal is provided and the pump can be deactivated.

Preferably, it is proposed that at least two, preferably each, of the at least one satellite reservoir are connected to the main reservoir via an individual fluid line. Such an embodiment results in a centralized or partly centralized topology. In particular, the cleaning liquid reservoir system includes a manifold, adapted to connect the individual fluid lines to the main reservoir or to a manifold fluid line connecting the main reservoir to the manifold. In such embodiments, fluid lines can be kept relatively short, as a single fluid line can be used to connect the manifold to the main reservoir, and only from the manifold several individual fluid lines are used to connect the satellite reservoirs in a specific region of the vehicle.

An embodiment suggests that the liquid sensing device is a fluid level sensor and is arranged in the satellite reservoir. Preferably, a fluid level sensor is arranged in each satellite reservoir. An embodiment where a fluid level sensor is arranged in each satellite reservoir enables a relatively exact determination of the level of cleaning liquid in each satellite reservoir and is particularly advantageous in embodiments where at least two satellite reservoirs are connected to the main reservoir via an individual fluid line. Preferably, the pump is adapted to be deactivated upon receiving the liquid presence signal from a fluid level sensor, more preferably from all fluid level sensors. Preferably, the electronic control unit and/or the consumption monitoring module is adapted to deactivate the pump when at least one liquid presence signal from a fluid level sensor, more preferably when the liquid presence signals from each fluid level sensor, are received. Such an embodiment ensures that the pump will be deactivated when the satellite reservoir, preferably all satellite reservoirs, are filled with cleaning liquid.

In accordance with a further embodiment, it is proposed that the satellite reservoir, preferably each satellite reservoir, includes a floating valve, adapted to close a fluid connection, preferably the individual fluid lines, when the further amount of the cleaning liquid in the satellite reservoir has reached a fluid level threshold. Such an embodiment ensures that the central supplying of a cleaning liquid by the pump is individually stopped for a specific individual fluid line when the corresponding satellite reservoir is filled, until every satellite reservoir is filled.

Preferably, it is proposed that at least one satellite reservoir includes a heating system, adapted to heat the cleaning liquid in the satellite reservoir. Via a heating system, a freezing of the cleaning liquid can be prevented. Via a heating system arranged in or at a satellite reservoir, only the further amount of cleaning liquid in the satellite reservoir is heated. Since in particular the further amount in the satellite reservoir is relatively small compared to the amount of cleaning liquid stored in the main reservoir, such an embodiment advantageously leads to smaller energy consumption for heating. Also, by equipping only specific satellite reservoirs that require heating, in particular not all satellite reservoirs, with a heating system, energy can be saved. Preferably, the heating system includes an electric heating element.

In accordance with a further embodiment, a consumption monitoring module is proposed, adapted to monitor a liquid monitoring value of the cleaning liquid, preferably via the liquid sensing device. Preferably, the electronic control module and/or the consumption monitoring module is adapted to provide a liquid request signal when the liquid monitoring value reaches a consumption monitoring threshold. Preferably, the liquid monitoring value is a numeral value characterizing the level of available cleaning liquid in the at least one satellite reservoir. In other embodiments, the liquid monitoring value can be a binary value that can have the value “1” when cleaning liquid is present and the value “0” when not, that is, when the liquid monitoring value is below the consumption monitoring threshold. Preferably, the consumption monitoring threshold is a minimum value of the liquid monitoring value, in particular when the level of cleaning fluid is at or below a minimum cleaning liquid level such as 20% or 10% of the capacity of the satellite reservoir. With a consumption monitoring module, it is possible to monitor the level and/or the actual consumption of cleaning liquids in a relatively exact manner.

Preferably, the electronic control module and/or the consumption monitoring module is adapted to provide a liquid request signal when a low cleaning liquid level has been determined by a fluid level sensor in at least one satellite reservoir. In comparison to a consumption estimation module, the consumption monitoring module can be an alternative or additional means for providing a liquid request signal for activating the pump on the basis of sensor data, rather than an algorithm-based estimation.

A maintenance advice signal can be in the form of a message displayed to the operator of the vehicle, indicating that cleaning fluid needs to be refilled. Preferably, the consumption monitoring module is adapted to determine the liquid monitoring value on the basis of one or more liquid presence signals. Via the consumption monitoring module, an overall consumption of cleaning fluid can be determined, in particular measured or approximated, via the liquid sensing devices, in particular the flow sensor or the fluid level sensors. By sensing the presence or consumption of cleaning liquid in the satellite reservoirs and/or the fluid line, the remaining level of cleaning liquid in the main reservoir can be estimated. By doing so, no further sensors are needed, in particular not in the main reservoir, for determining an overall consumption of cleaning liquid of the cleaning liquid reservoir system. Preferably, the electronic control module and/or the consumption monitoring module is adapted to provide a maintenance advice signal when the determined overall consumption of cleaning fluid signalizes a low level of cleaning fluid in the main reservoir.

Preferably, the main reservoir includes a main fluid level sensor that is adapted to determine the liquid monitoring value and/or the current level of cleaning liquid in the main reservoir. Preferably, the main fluid level sensor is adapted to provide a signal, in particular a maintenance advice signal, when the level of cleaning liquid in the main reservoir, that is the main amount of cleaning liquid, is equal to or below a minimum cleaning liquid level. Preferably, the main fluid level sensor is connected to the electronic control unit and/or to the consumption monitoring module. The expression “fluid level” refers to the level of a liquid.

Preferably, the electronic control unit, more preferably the consumption monitoring module and/or the consumption estimation module, is adapted to provide a warning message, in particular a maintenance advice signal, when the level of cleaning liquid in the main reservoir, that is the main amount of cleaning liquid, is equal to or below a minimum cleaning liquid level.

In accordance with a further embodiment, the distance between the main reservoir and the at least one satellite reservoir, and preferably further between each satellite reservoir, is in a range from 0,5 m to 20 m, preferably from 1 m to 10 m. Preferably, the length of the fluid line, or a fluid line segment or an individual fluid line or the fluid return line is in a range from 0,5 m to 20 m, preferably from 1 m to 10 m. Preferably, the fluid line and/or the fluid line segment and/or the individual fluid line and/or the fluid return line is a hose, pipe or the like liquid connection means.

In a second aspect of the disclosure, a sensor cleaning system for a vehicle is proposed, including a cleaning liquid reservoir system according to the first aspect of the disclosure, and at least one sensor cleaning module, adapted to provide a cleaning fluid to at least one cleaning nozzle.

In a third aspect of the disclosure, a vehicle is proposed, preferably a commercial vehicle or a passenger vehicle, including a cleaning liquid reservoir system according to the first aspect of the disclosure and/or a sensor cleaning system according to the second aspect of the disclosure.

It shall be understood that the cleaning liquid reservoir system according to the first aspect of the disclosure, the sensor cleaning system according to the second aspect of the disclosure and the vehicle according to the third aspect of the disclosure include identical or similar embodiments, in particular as described in the dependent claims. Therefore, an embodiment of one aspect of the disclosure is also applicable to another aspect of the disclosure.

### BRIEF DESCRIPTION OF DRAWINGS

The invention will now be described with reference to the drawings wherein:

FIG. 1 shows a first embodiment of the disclosure with a plurality of three satellite reservoirs in a serial topology and a flow sensor arranged in a liquid return line;

FIG. 2 shows a second embodiment of the disclosure with a plurality of three satellite reservoirs in a serial topology and fluid level sensors arranged in each satellite reservoir;

FIG. 3 shows a third embodiment of the disclosure with a plurality of three satellite reservoirs in a centralized topology with respect to a manifold and fluid level sensors arranged in each satellite reservoir; and,

FIG. 4 shows a vehicle including a cleaning liquid reservoir system according to the first aspect of the disclosure.

### DETAILED DESCRIPTION

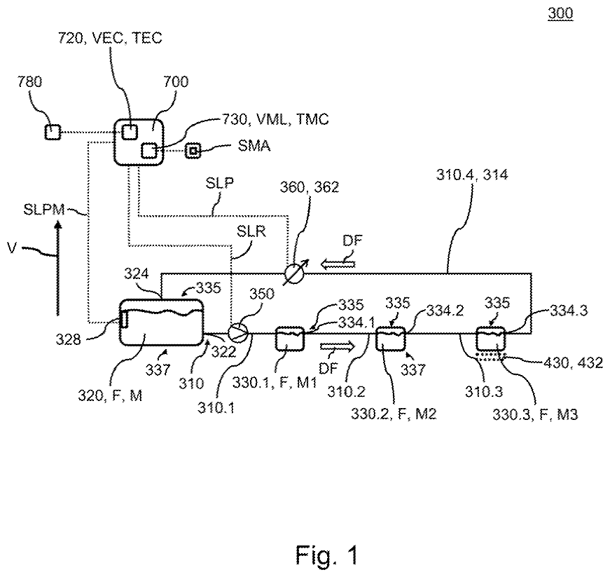

FIG. 1 shows a cleaning liquid reservoir system 300 according to a first embodiment of the disclosure. The cleaning liquid reservoir system 300 includes a main reservoir 320, adapted to store a main amount M of a cleaning liquid F. The main reservoir 320 includes a main liquid exit port 322, which is located in a bottom region 337 of the main reservoir 320. “Bottom region” refers to a region of a reservoir in the lower 25%, preferably in the lower 10%, more preferably in the lower 5% of the reservoir, wherein “lower” refers to a vertical vehicle axis V. The main liquid exit port 322 is connected to a pump 350 in a liquid transferring manner. The pump 350 is adapted to pump the cleaning fluid F in a fluid flow direction DF from the main reservoir 320 through a fluid line 310. The pump 350 is arranged in a first fluid line segment 310.1 of the fluid line 310. The fluid line 310 extends from the main liquid exit port 322 to the pump 350 and further to a plurality of satellite reservoirs 330 connected in series and further back to a main liquid entrance port 324 of the main reservoir 320. The main liquid entrance port 324 is arranged in a top region of the main reservoir 320. “Top region” refers to a region of a reservoir in the upper 25%, preferably in the upper 10%, more preferably in the upper 5% of the reservoir, wherein “upper” refers to the vertical vehicle axis V.

The cleaning liquid reservoir system 300 includes a first satellite reservoir 330.1, a second satellite reservoir 330.2 and a third satellite reservoir 330.3.

The first satellite reservoir 330.1 is adapted to store a first further amount M1 of cleaning liquid F and is connected to the pump 350, and the main reservoir 320, via a first fluid line segment 310.1 of the fluid line 310. The first satellite reservoir 330.1 includes a first liquid exit port 334.1 which is arranged in the top region 335 of the first satellite reservoir 330.2. The first satellite reservoir 330.1 is connected via the first liquid exit port 334.1 via a second fluid line segment 310.2 to a second satellite reservoir 330.2.

The second satellite reservoir 330.2 is adapted to store a second further amount M2 of cleaning liquid. The second satellite reservoir 330.2 includes a second liquid exit port 334.2, which is arranged in the top region 335 of the second satellite reservoir 330.2. The second satellite reservoir 330.2 is connected via the second liquid exit port 334.2 via a third fluid line segment 310.3 to a third satellite reservoir 330.3.

The third satellite reservoir 330.3 is adapted to store a third further amount M3 of cleaning liquid F. The third satellite reservoir 330.3 includes a third liquid exit port 334.3, which is arranged in the top region of the third satellite reservoir 330.3. The third satellite reservoir 330.3 is connected via the third liquid exit port 334.3 via a fourth fluid line segment 310.4 to the main liquid entrance port 324 of the main reservoir 320. The fourth fluid line segment 310.4 is the return line 314 of the cleaning liquid reservoir system 300.

The cleaning liquid reservoir system 300 includes a liquid sensing device 360. The liquid sensing device 360 in this embodiment is a flow sensor 362, that is arranged in the liquid return line 314. The flow sensor 362 is adapted to provide a liquid presence signal SLP when cleaning liquid F is present at the liquid sensing device 360. The liquid sensing device 360 is electrically, here electronically, connected to an electronic control unit 700. The electronic control unit 700 is electrically connected to the pump 350 and is adapted to provide a liquid request signal SLR to the pump 350 in order to activate the pump 350 for pumping cleaning fluid F.

The electronic control unit 700 is adapted to provide a liquid request signal SLR when no liquid presence signal SLP is received from the flow sensor 362, and preferably when also the consumption estimation module 720 signalizes that the consumption estimation value VEC has reached a consumption estimation threshold TEC. The electronic control unit 700 is further adapted to provide no liquid request signal SLR when a liquid presence signal SLP is received from the flow sensor 362. When the pump 350 is activated via the liquid request signal SLR, the pump 350 is pumping cleaning liquid F from the main reservoir 322 the first satellite reservoir 330.1. The liquid request signal SLR can be an electric or electronic signal. Preferably, as it is the case here, the liquid request signal SLR is an electric voltage. Due to the position of the first liquid exit port 334.1 in the top region 335 of the first satellite reservoir 330.1, the cleaning liquid F will continue to flow to the second satellite reservoir 330.2 when its level has reached the top region 335 of the first satellite reservoir 330.1. The above stated applies for the second and third satellite reservoir 330.2, 330.3 with according numbering of the reference signs.

When the last satellite reservoir 330 connected in series, here the third satellite reservoir 330.3, is filled up to its top region 335, the cleaning liquid F will eventually reach the return line 314, where its presence is detected by the liquid sensing device 360. Thus, by the described topology of main reservoir 320, satellite reservoirs 330 and liquid sensing device 360 in the form of the flow sensor 362, it can be detected when the filling of the satellite reservoirs is completed.

In the embodiment shown, the electronic control unit 700 includes a consumption estimation module 720. The consumption estimation module 720 is adapted to estimate a consumption estimation value VEC of the cleaning liquid F and further to provide the liquid request signal SLR when the consumption estimation value VEC reaches a consumption estimation threshold TEC.

Preferably, as shown here, the consumption estimation module 320 is adapted to count the cleaning cycles of the sensor cleaning modules that are supplied by the satellite reservoirs 330.1, 330.2, 330.3. By doing so, the amount of consumed cleaning liquid F can be estimated, in particular individually for each satellite reservoir. The consumption estimation module 720 and/or the electronic control unit 700 is electronically connected to a sensor cleaning control unit 780 of the sensor cleaning modules 100 or the sensor cleaning system 200, in particular for the counting of the cleaning cycles. A cleaning cycle describes an application of a specific amount of cleaning liquid to a sensor surface.

In various embodiments, the sensor cleaning control unit 780 is part of the electronic control unit 700.

As exemplarily shown here for the third satellite reservoir 330.3, any embodiment can include one or more heating systems 430 for heating the cleaning liquid F. Preferably, as shown here, the heating system 430 includes at least one heating element 432 and can be arranged at or in a satellite reservoir 330 for heating the further amount of cleaning liquid F contained therein.

In optional embodiments, the main reservoir 320 can include a main fluid level sensor 328, adapted to determine the level of cleaning liquid F in the main reservoir 320 and to provide a main liquid presence signal SLPM, indicating the presence and/or the level of cleaning liquid F.

Preferably, as shown here, the cleaning liquid reservoir system 300 can include a consumption monitoring module 730, adapted to monitor a liquid monitoring value VML of the cleaning liquid F. The consumption monitoring module 730 is adapted to determine the liquid monitoring value VML via the liquid sensing device 360 or by a main liquid presence signal SLPM of the main fluid level sensor 328 arranged in the main reservoir. The consumption monitoring module 730 is adapted to provide a maintenance advice signal SMA, when the liquid monitoring value VML reaches a consumption monitoring threshold TMC. In the case of the flow sensor 362 in the shown embodiment, the consumption monitoring module 730 can be adapted to provide a maintenance advice signal SMA when no liquid presence signal SLP is provided by the flow sensor 362 after the pump 350 has been activated for a specified amount of time. In other embodiments, the consumption monitoring module 730 can additionally or alternatively be connected to other liquid sensing devices, for example, one or more fluid level sensors in the satellite reservoirs.

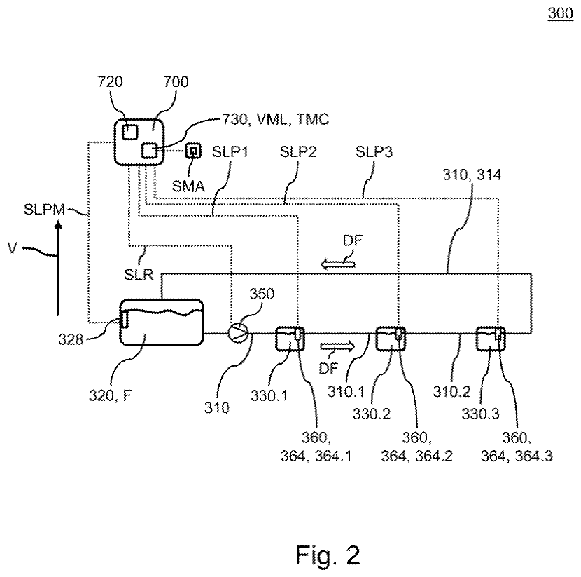

FIG. 2 shows a second embodiment of the cleaning liquid reservoir system 300 according to an aspect of the disclosure. In comparison to the first embodiment shown in FIG. 1, each satellite reservoir 330 includes a liquid sensing device 360 in the form of a fluid level sensor 364. That is, the first satellite reservoir 330.1 includes a first fluid level sensor 364.1 adapted to provide a first liquid presence signal SLP1, the second satellite reservoir 330.2 includes a second fluid level sensor 364.2 adapted to provide second liquid presence signal SLP2, and the third satellite reservoir 330.3 includes a third fluid level sensor 364.3 adapted to provide a third liquid presence signal SLP3. Further, the cleaning liquid reservoir system 300 shown here does not include a liquid sensing device arranged in the return line 314. Via the shown liquid sensing devices 360, the level of cleaning liquid F in each satellite reservoir 330 can be determined individually and thus, the current state of the cleaning liquid reservoir system 300 can be determined more accurately with regard to the cleaning liquid F. In particular, a liquid monitoring value VML can be determined by the consumption monitoring module 730 on the basis of the liquid presence signals SLP1, SLP2, SLP3, and/or a main liquid presence signal SLPM of the main fluid level sensor 328. The consumption monitoring module 730 is preferably adapted to provide the liquid request signal SLR to the pump 350 when the liquid monitoring value VML in at least one satellite reservoir 330 is equal to or below the consumption monitoring threshold TMC.

In the second embodiment, the electronic control unit 700 is adapted to activate the pump 350 via the liquid request signal SLR when one of the liquid presence signals SLP1, SLP2. SLP3 indicates the lack or low level of cleaning fluid F in the corresponding satellite reservoir 330.1, 330.2, 330.3. Due to the serial structure, and analogously to the first embodiment shown in FIG. 1, the satellite reservoirs 330.1 330.2, 330.3 will be refilled with cleaning fluid F subsequently upon activation of the pump 350.

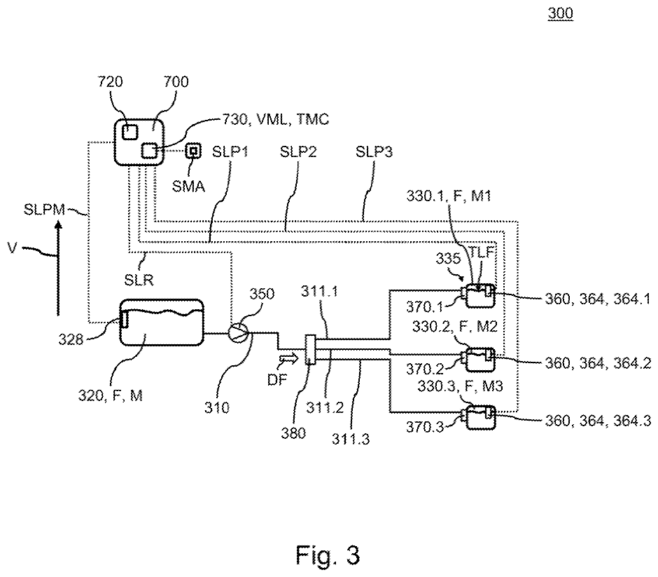

FIG. 3 shows third embodiment of a cleaning liquid reservoir system 300 according to an aspect of the disclosure. In comparison to the second embodiment shown in FIG. 2, the three satellite reservoirs 330.1, 330.2, 330.3 are arranged in parallel and connected to a manifold 380. That is, the first satellite reservoir 330.1 is connected to the manifold 380 via a first individual fluid line 311.1, the second satellite reservoir 330.2 is connected via a second individual fluid line 311.2, and the third satellite reservoir 330.3 is connected via a third individual fluid line 311.3. The manifold 380 is connected to the pump 350 and the main reservoir 320, respectively, via the fluid line 310. There is no return line 314. Further, each satellite reservoir 330.1, 330.2, 330.3 includes a floating valve 370.1, 370.2, 370.3, which is adapted to close the liquid transferring connection of the individual fluid line 311.1, 311.2, 311.3 when the satellite reservoir 330.1, 330.2, 330.3 is filled with cleaning liquid F, in particular filled to its top region 350. That is, when a fluid level threshold TLF is reached. Via a floating valve 370, the filling of an individual satellite reservoir 330 can be stopped when its fluid level threshold TLF is reached, whereas the filling of other satellite reservoirs 330 continue. When all satellite reservoirs 330.1, 330.2, 330.3 are filled with cleaning liquid F, preferably when all liquid presence signals SLP1, SLP2, SLP3 are provided, the pump 350 is stopped, in particular the electronic control unit 700 stops providing a liquid request signal SLR.

In comparison to the first and second embodiment shown in FIG. 1 and FIG. 2 that include a closed circuit of cleaning fluid F, the third embodiment shown in FIG. 3 includes an open circuit of cleaning fluid F, as there is no return line 314.

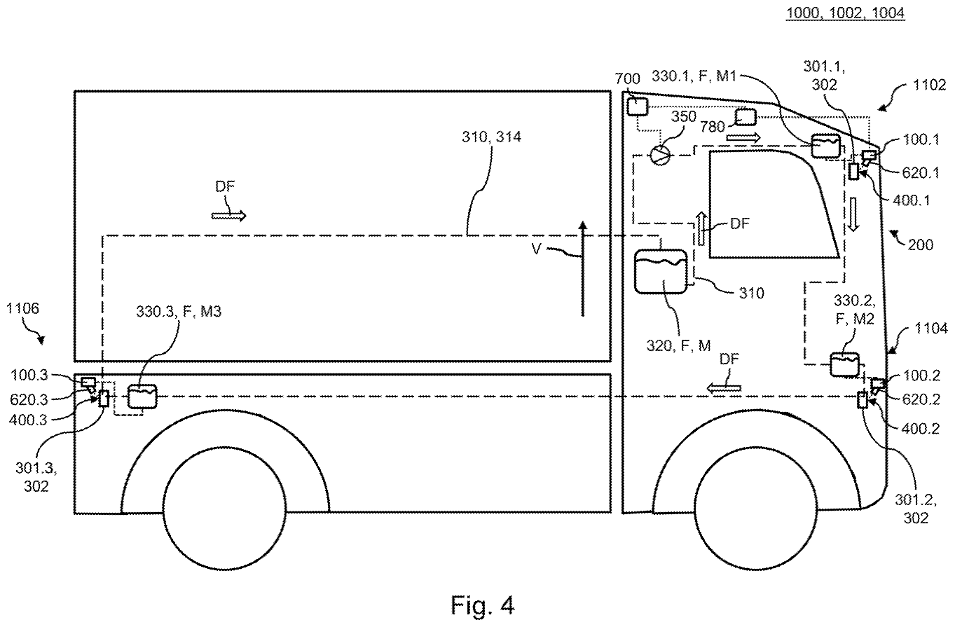

FIG. 4 shows a vehicle 1000 in the form of a commercial vehicle 1002 including a sensor cleaning system 200 with sensor cleaning modules 100.1, 100.2, 100.3 and a cleaning liquid reservoir system 300 according to an aspect of the disclosure. In other embodiments, the vehicle 1000 can be of different type, such as a passenger vehicle 1004 or the like. The sensor cleaning system 200 is controlled by a sensor cleaning control unit 780, whereas one electronic connection to the first sensor cleaning module 100.1 is exemplarily shown in FIG. 4. In other embodiments, the electronic control unit 700 of the cleaning liquid reservoir system 300 and the sensor cleaning control unit 780 can be one hardware or software module. In again other embodiments, the electronic control unit 700 of the cleaning liquid reservoir system 300 and the sensor cleaning control unit 780 each can be part of a different hardware or software module of the vehicle 1000.

In particular, the cleaning liquid reservoir system 300 can be of the type of the first embodiment shown in FIG. 1 or of the second embodiment shown in FIG. 2, as the position and type of the liquid sensing device 360 is not shown. However, also any other embodiment of the disclosure can be applied in such vehicle 1000, such as the third embodiment shown in FIG. 3.

The cleaning liquid reservoir system 300 includes three serially arranged satellite reservoirs 330.1, 330.2, 330.3. The first satellite reservoir 330.1 is arranged in an upper front region 1102 of the vehicle 1000 and is connected to a first sensor cleaning module 100.1 with the first cleaning nozzle 620.1. The first sensor cleaning module 100.1 is adapted to clean a first sensor surface 400.1, which is also arranged in the upper front region 1102. The first satellite reservoir 330.1 is adapted to provide cleaning fluid F to the first sensor cleaning module 100.1.

Analogously to the above described first satellite reservoir 330.1, the second satellite reservoir 330.2 is connected to a second sensor cleaning module 100.2, which is assigned to a second sensor surface 400.2, and the third satellite reservoir 330.3 is connected to a third sensor cleaning module 100.3, which again is assigned to a third sensor surface 400.3.

The second satellite reservoir 330.2 and the second sensor cleaning module 100.2 are arranged in a lower front region 1104 of the vehicle 1000. The third satellite reservoir 330.3 and the third sensor cleaning module 100.3 are arranged in a lower rear region 1106 of the vehicle 1000. Also here, the expressions “upper” and “lower” refers to a vertical vehicle axis V.

With the cleaning liquid reservoir system 300, an efficient spatial distribution of satellite reservoirs 330 is achieved, in particular with a relatively short fluid line lengths as well as relatively few and simple fluidic components such as liquid sensing devices, pumps and the like. Further, through the spatial distribution, the satellite reservoirs can be arranged closed to the sensor cleaning modules, resulting in reduced pressure losses and thus, and energy efficient operation and a good cleaning performance.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

100 sensor cleaning module

100.1-3 first to third sensor cleaning module

200 sensor cleaning system

300 cleaning liquid reservoir system

310 fluid line

310.1-4 first to fourth fluid line segment

311 individual fluid line

311.1-3 first to third individual fluid line

314 return line

320 main reservoir

322 main liquid exit port

324 main liquid entrance port

328 main fluid level sensor

330 satellite reservoir

330.1-3 first to third satellite reservoir

334 liquid exit port of the satellite reservoir

334.1-3 first to third liquid exit port

335 top region of the satellite or main reservoir

337 bottom region of the satellite or main reservoir

350 pump

360 liquid sensing device

362 flow sensor

364 fluid level sensor

364.1-3 first to third fluid level sensor

370 floating valve

370.1-3 first to third floating valve

380 manifold

400 sensor surface

400.1-3 first to third sensor surface

430 heating system

432 heating element

620 cleaning nozzle

620.1-3 first to third cleaning nozzle

700 electronic control unit

720 consumption estimation module

780 sensor cleaning control unit

1000 vehicle

1002 commercial vehicle

1004 passenger vehicle

1102 upper front region of the vehicle

1104 lower front region of the vehicle

1106 lower rear region of the vehicle

DF fluid flow direction

F cleaning liquid

M main amount

M1, M2, M3 first, second, third further amount

SLP liquid presence signal

SLP1, SLP2, SLP3 first to third liquid presence signal

SLPM main liquid presence signal

SLR liquid request signal

SMA maintenance advice signal

TEC consumption estimation threshold

TLF fluid level threshold

TMC consumption monitoring threshold

V vertical vehicle axis

VEC consumption estimation value

VML liquid monitoring value

1. A cleaning liquid reservoir system for a vehicle, configured to store a cleaning liquid for cleaning at least one surface of the vehicle, the cleaning liquid reservoir system comprising:
a main reservoir configured to store a main amount of the cleaning liquid;
a pump for pumping the cleaning liquid;
at least one satellite reservoir configured to store a further amount of the cleaning liquid;
a liquid sensing device configured to detect a presence of the cleaning liquid outside of said main reservoir and to provide a liquid presence signal when the presence of the cleaning liquid outside said main reservoir is detected;
the main reservoir being connected to said at least one satellite reservoir via a fluid line;
said pump being configured to pump the cleaning liquid from said main reservoir to said at least one satellite reservoir; and,
said pump being further configured to be deactivated upon receiving said liquid presence signal.

2. The cleaning liquid reservoir system of claim 1 further comprising:
a consumption estimation module configured to estimate a consumption estimation value of the cleaning liquid and to provide a liquid request signal when said consumption estimation value reaches a consumption estimation threshold; and,
said pump being configured to be activated upon receiving said liquid request signal.

3. The cleaning liquid reservoir system of claim 2 further comprising an electronic control unit configured to control said pump in dependence upon at least one of said liquid presence signal and said liquid request signal.

4. The cleaning liquid reservoir system of claim 1, wherein said at least one satellite reservoir has a plurality of liquid exit ports arranged in a top region of said satellite tank.

5. The cleaning liquid reservoir system of claim 1, wherein the cleaning liquid reservoir system includes at least two satellite reservoirs which are connected to said main reservoir in series via said fluid line.

6. The cleaning liquid reservoir system of claim 1, wherein each one of said at least one satellite reservoir is connected to said main reservoir in series via said fluid line.

7. The cleaning liquid reservoir system of claim 1, wherein said liquid sensing device is a flow sensor.

8. The cleaning liquid reservoir system of claim 7, wherein said flow sensor is arranged in a liquid return line connecting a last in a series of said at least one satellite reservoir and said main reservoir.

9. The cleaning liquid reservoir system of claim 1, wherein the cleaning liquid reservoir system includes at least two satellite reservoirs which are connected to said main reservoir via an individual fluid line.

10. The cleaning liquid reservoir system of claim 1 wherein each one of said at least one satellite reservoir is connected to said main reservoir in series via an individual fluid line.

11. The cleaning liquid reservoir system of claim 1, wherein said liquid sensing device is a fluid level sensor and is arranged in said at least one satellite reservoir.

12. The cleaning liquid reservoir system of claim 11, wherein the cleaning liquid reservoir system includes a plurality of satellite reservoirs and a fluid level sensor is arranged in each of said plurality of satellite reservoirs.

13. The cleaning liquid reservoir system of claim 12, wherein said pump is configured to be deactivated upon receiving said liquid presence signal from all of said fluid level sensors.

14. The cleaning liquid reservoir system of claim 1, wherein said at least one satellite reservoir includes a floating valve configured to close a fluid connection when the further amount of the cleaning liquid in the satellite reservoir has reached a fluid level threshold.

15. The cleaning liquid reservoir system of claim 10, wherein said at least one satellite reservoir includes a floating valve configured to close the individual fluid lines when the further amount of the cleaning liquid in the at least one satellite reservoir has reached a fluid level threshold.

16. The cleaning liquid reservoir system of claim 1, wherein said at least one satellite reservoir includes a heating system configured to heat the cleaning liquid in the satellite reservoir.

17. The cleaning liquid reservoir system of claim 1 further comprising:
a consumption monitoring module configured to monitor a liquid monitoring value of the cleaning liquid and to provide a liquid request signal when said liquid monitoring value reaches a consumption monitoring threshold.

18. The cleaning liquid reservoir system of claim 17, wherein said consumption monitoring module monitors said liquid monitoring value via said liquid sensing device.

19. A sensor cleaning system for a vehicle, the sensor cleaning system comprising:
a cleaning liquid reservoir system configured to store a cleaning liquid for cleaning at least one surface of the vehicle;
said cleaning liquid reservoir including a main reservoir configured to store a main amount of the cleaning liquid;
said cleaning liquid reservoir further including a pump for pumping the cleaning liquid and at least one satellite reservoir configured to store a further amount of the cleaning liquid;
said cleaning liquid reservoir including a liquid sensing device configured to detect a presence of the cleaning liquid outside of said main reservoir and to provide a liquid presence signal when the presence of the cleaning liquid outside said main reservoir is detected;
said main reservoir being connected to said at least one satellite reservoir via a fluid line;
said pump being configured to pump the cleaning liquid from said main reservoir to said at least one satellite reservoir;
said pump being further configured to be deactivated upon receiving said liquid presence signal; and,
at least one sensor cleaning module configured to provide the cleaning fluid to at least one cleaning nozzle.

20. A vehicle comprising the cleaning liquid reservoir system of claim 1.

21. A vehicle comprising the sensor cleaning system of claim 19.
